(19) United States
(12) Patent Application Publication
(10) Pub. No.: US 2013/0046820 A1
(43) Pub. Date: Feb. 21, 2013

(54) Manipulaton of an Inventory of Content Items on a Mobile Device by a Network-Based Application

(71) Applicants: CYNTHIA WONG, MOUNTAIN VIEW, CA (US); DAVID P. CONWAY, LOS ALTOS, CA (US)

(72) Inventors: CYNTHIA WONG, MOUNTAIN VIEW, CA (US); DAVID P. CONWAY, LOS ALTOS, CA (US)

(21) Appl. No.: 13/657,589

(22) Filed: Oct. 22, 2012

Related U.S. Application Data
(63) Continuation of application No. 13/075,983, filed on Mar. 30, 2011.

(51) Int. Cl. G06F 15/16

(52) U.S. Cl. 709/203

(57) ABSTRACT

A method of modifying, with a network-based application, an inventory of one or more content items on a mobile device is provided. The method may include receiving, over a network at a client computer, from the server, the inventory on the mobile device. Next, a graphical depiction of the mobile device is presented on the client computer, the graphical depiction showing the inventory as the inventory would appear on a display of the mobile device. A request for a modification of the inventory is received by the client computer, and the request is sent to the mobile device over the network via the server.

### CROSS REFERENCE TO RELATED APPLICATIONS

This application claims benefit as a continuation to pending U.S. patent application Ser. No. 13/075,983, filed Mar. 30, 2011, entitled “Manipulation of Device Content by a Network-Based Application,” this application hereby incorporated herein by reference as if fully set forth herein.

### BACKGROUND

1. Field

The field relates to managing content items on a mobile device.

2. Related Art

Mobile phones, tablet computers, netbooks, and television set-top boxes are different types of electronic devices that allow the use of different types of content. Each of these types of devices may hold different types of content items and have different settings and capabilities.

As the broad use of different types of content devices continues to increase, there is an increasing need for an improved, integrated approach to adding, removing and managing content items and configuration settings on different devices.

### BRIEF SUMMARY

Embodiments described herein relate to a method, apparatus and computer program product for modifying an inventory of content items on a mobile. According to an embodiment, a method of modifying, with a network-based application operating on a server, an inventory of one or more content items on a mobile device is provided. The method may include receiving, over a network at a client computer, from the server, the inventory on the mobile device. Next, a graphical depiction of the mobile device is presented on the client computer, the graphical depiction showing the inventory as the inventory would appear on a display of the mobile device. A request for a modification of the inventory is received by the client computer, and the request is sent to the mobile device over the network via the server.

In another embodiment, a network-based application includes a content item processor that receives information describing an inventory of one or more content items from a device. A user interface (UI) replicator receives a UI signal from the device, the UI signal corresponding to a state of a UI on the device, and generates, at a client computer, a graphical depiction of the state of the UI on the device. The generated graphical depiction shows the inventory as it would appear on the UI of the device. The content item processor receives a request to modify the inventory from the client computer and generates a modification signal to send to the device based on the request. The modification signal is sent by the content item processor to the device,

### BRIEF DESCRIPTION OF THE FIGURES

The accompanying drawings, which are incorporated in and constitute part of the specification, illustrate embodiments and, together with the general description given above and the detailed description of embodiments given below, serve to explain the principles of the present invention. In the drawings:

FIG. 1 is a block diagram depicting an example network application architecture, according to an embodiment.

FIG. 2 is a block diagram of a more detailed view of a mobile device, according to an embodiment.

FIG. 3 is a block diagram of a more detailed view of the user interface of a network-based application to an embodiment.

FIG. 4 is another block diagram of a more detailed view of a mobile device, according to an embodiment.

FIG. 5 is another block diagram of a more detailed view of the user interface of a network-based application to an embodiment.

FIG. 6 is another block diagram of a more detailed view of a mobile device, according to an embodiment.

FIG. 7 is another block diagram of a more detailed view of the user interface of a network-based application to an embodiment.

FIG. 8 is a block diagram of a more detailed view of a server, according to an embodiment.

FIG. 9 is a block diagram of a more detailed view of a client system, according to an embodiment.

FIG. 10 is a block diagram depicting an example network application architecture, according to an embodiment.

FIG. 11 shows a flowchart illustrating a method of automatically tuning a software application according to an embodiment of the invention.

FIG. 12 depicts a sample computer system that may be used to implement an embodiment.

### DETAILED DESCRIPTION

The following detailed description refers to the accompanying drawings that illustrate exemplary embodiments. Other embodiments are possible, and modifications may be made to the embodiments within the spirit and scope of the invention. Therefore, the detailed description is not meant to limit the invention. Rather, the scope of the invention is defined by the appended claims.

Features and advantages of the invention are set forth in the description that follows, and in part are apparent from the description, or may be learned by practice of the invention. The advantages of the invention are realized and attained by the structure and particularly pointed out in the written description and claims hereof as well as the appended drawings. The following detailed description is exemplary and explanatory and is intended to provide further explanation of the invention as claimed.

The embodiment(s) described and references in the specification to “one embodiment,” “an embodiment,” “an example embodiment,” etc., indicate that the embodiment(s) described may include a particular feature, structure, or characteristic. However, every embodiment may not necessarily include the particular feature, structure or characteristic. Moreover, such phrases are not necessarily referring to the same embodiment. When a particular feature, structure or characteristic is described in connection with an embodiment, it is understood that it is within the knowledge of one skilled in the art to effect such feature, structure, or characteristic in connection with other embodiments, whether or not explicitly described.

It would be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments is described with the understanding that modifications and variations of the embodiments are possible, given the level of detail presented herein.

### Overview

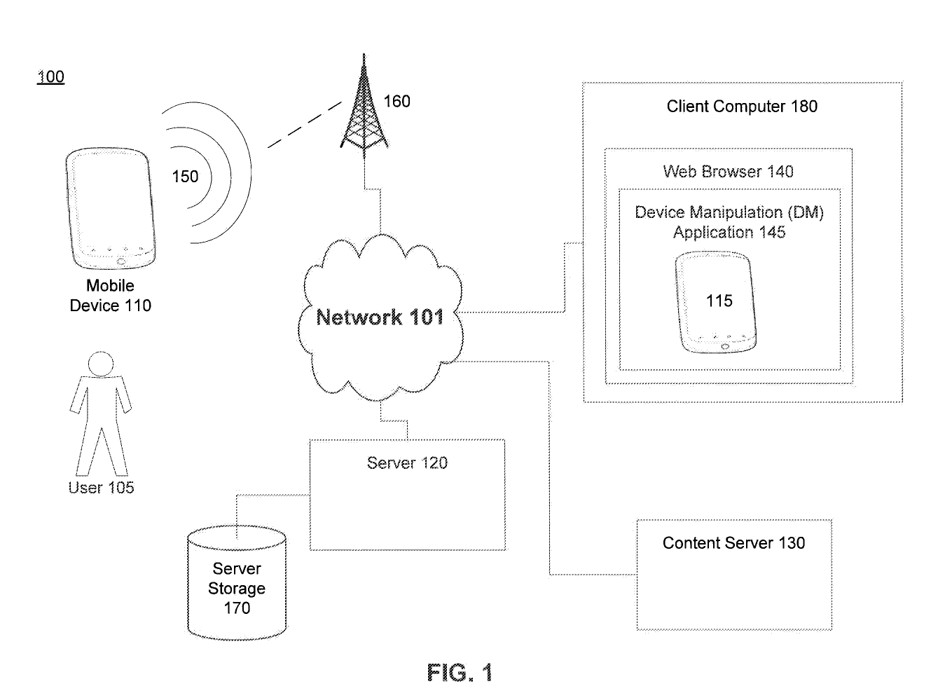

Generally speaking, some embodiments described herein provide a simplified approach for device users to manage content items on one or more devices using a network-based application. In different embodiments, devices that can be manipulated include mobile devices, such as mobile phones, and non-mobile devices, such as set-top boxes (STBs) and computers. It is important to note that, while an exemplary embodiment is described with the discussion of FIGS. 1-7 that includes references to a mobile device, any type of device that holds content can be managed by embodiments.

In an embodiment, a network-based application is provided that displays user manipulable graphical representations of the managed devices. User manipulations can involve changing, adding and deleting content items on the managed devices. In an embodiment, once the changes are made in the network-based application, the changes can be effected automatically on the one or more devices by sending a modification request to the devices over a network.

FIG. 1 depicts an example network application architecture 100 in which embodiments of the present invention, or portions thereof, may be implemented. Network application architecture 100 includes the following components linked by network 101: server 120, wireless transceiver 160, client computer 180 and content server 130. Mobile device 110 is linked by wireless signal 150 to wireless transceiver 160. Client computer 180 includes web browser 140. Web browser 140 includes device manipulation application (DM application) 145, such DM application 145 depicting device representation 115.

As used herein, network 101 may be any network or combination of networks that can carry data communications. Such network 101 can include, but is not limited to, a local area network, medium area network, and/or wide area network such as the Internet. Network 101 can support protocols and technology including, but not limited to, World Wide Web protocols and/or services. Intermediate web servers, gateways, or other servers may be provided between components of the depicted network components depending upon a particular application or environment.

As used herein, mobile device 110 may be any type of portable microprocessor-based, user operated device. Typically, as used herein, mobile device 110 may refer to: a mobile phone, a smart phone and a tablet computer. An exemplary embodiment of mobile device 110 includes wireless connectivity through a broadband wireless network, for example mobile device 110 using wireless signal 150 to connect to network 101 via wireless transceiver 160. As noted above, non-mobile devices can also be managed by embodiments, in approaches similar to those discussed with respect to mobile device 110.

As used typically herein, a network-based application is an application with functions distributed between two or more computers linked by a network. In an embodiment of a network-based application described herein, content item verifying and processing functions are performed on a server computer and a user interface is hosted on a client computer. In this example, the client and server computers are linked by a network, for example, the Internet, the client user interface generated using a hypertext transfer protocol (HTTP), and executed with a web browser. In different embodiments, different configurations, functions, networks and computers can be used.

In the example embodiment noted above, the network-based application is a World Wide Web (WWW) based application executed using a web browser, e.g., DM application 145 executed by web browser 140 in FIG. 1. In the embodiment shown on FIG. 1, DM application 145 is a web-browser 140 implemented network-based application, but it is important to note that the functions described herein performed by DM application 145 can be performed by a stand-alone and non-browser based applications as well (not shown).

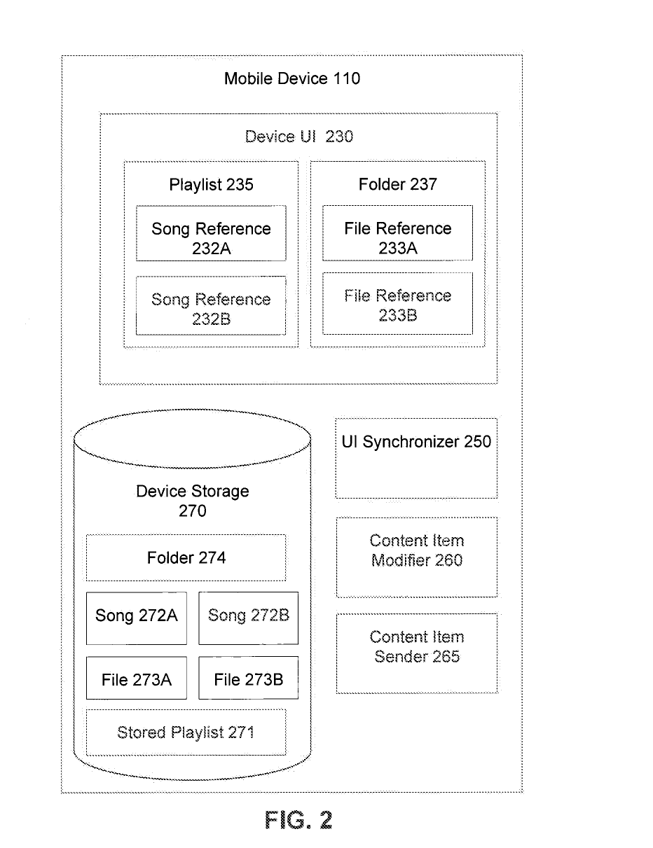

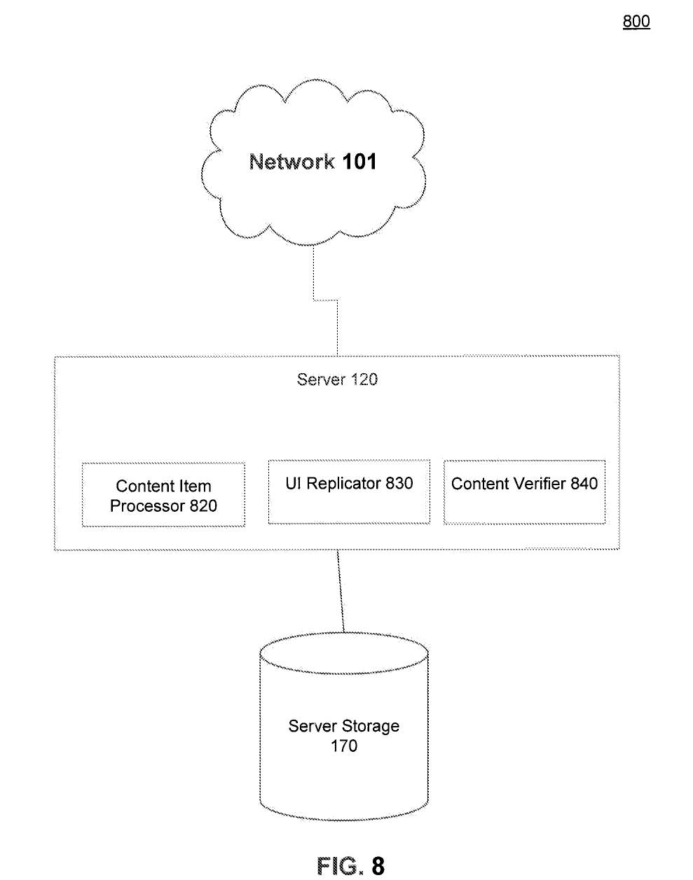

As would be appreciated by one having skill in the relevant art(s), network-based applications generally have a server-side component, e.g., server 120. Server 120 has the host/server-side components of DM application 145, and links, via network 101 to components on mobile device 110, client computer 180 and content server 130. Further details regarding the operation of different synchronization components on mobile device 110 are provided with the description of FIGS. 2A-B, 3A-B and 4A-B below, according to an embodiment. Further details regarding the operation of server 120 are provided with the description of FIG. 8 below, according to an embodiment.

In an example, network application architecture 100 supports a method of changing, with a DM application 145, a content item on mobile device 110. Mobile device 110 sends a content item, via wireless transceiver 160 and network 101, to server 120. Server 120 sends the content item to DM application 145 for display to a user as device representation 115.

When a user modifies device representation 115, DM application 145 sends a corresponding request for modification to server 120. Server 120 sends the request for modification to the mobile device 110. At mobile device 110, the request for modification is received and the corresponding content item is modified in accordance with the modification request.

In another example, network application architecture 100 supports method of adding a content item to a mobile device 110 with a DM application 145. Mobile device 110 sends a content item inventory, via wireless transceiver 160 and network 101, to server 120. Server 120 sends the content item inventory to DM application 145 for display to a user as device representation 115.

When a user, by modifying device representation 115, indicates a request to add a content item to mobile device 110, DM application 145 sends a corresponding request for addition to server 120. Server 120 receives the request for addition and sends the request for addition of the content item and the content item to mobile device 110. The content item can be stored in server storage 170 or provided to server 120 by different sources, including content server 130 and client computer 180.

At mobile device 110, the request for addition and the content item are received and the content item is added to mobile device 110. The following sections detail additional embodiments Where content items are modified and added to different devices using a process similar to the one described above.

Further details and embodiments are provided below; according to different embodiments.

### Content Items

FIG. 2 depicts a more detailed view of mobile device 110 according to an embodiment. Mobile device 110 includes device user interface (Device UI) 230, user interface synchronizer (UI synchronizer) 250, content item modifier 260, content item sender 265 and device storage 270. Device UI displays playlist 235 and folder 237, each described with items C1 and C2 respectively below. Device storage 270 stores different exemplary content items, including stored playlist 271, folder 274, songs 272A-B and files 273A-B.

As used broadly herein for embodiments, a “content item” can refer to a variety of different items stored on mobile device 110. Items C1-C6 listed below are intended to be non-limiting examples of different types of content items. Example content items C1-C6 are listed as follows:

C1. Playlists: Example playlist 235 stores and displays a list of song references 232A-B. Each song reference 232A-B refers respectively to corresponding songs 272A-B stored in device storage 270. Thus, in an embodiment, a playlist is a content item that contains one or more references to other content items, for example, songs. An example of a modification to the playlist content item includes the addition and removal of song references from the playlist, and changing the display names of the songs in playlist 235.

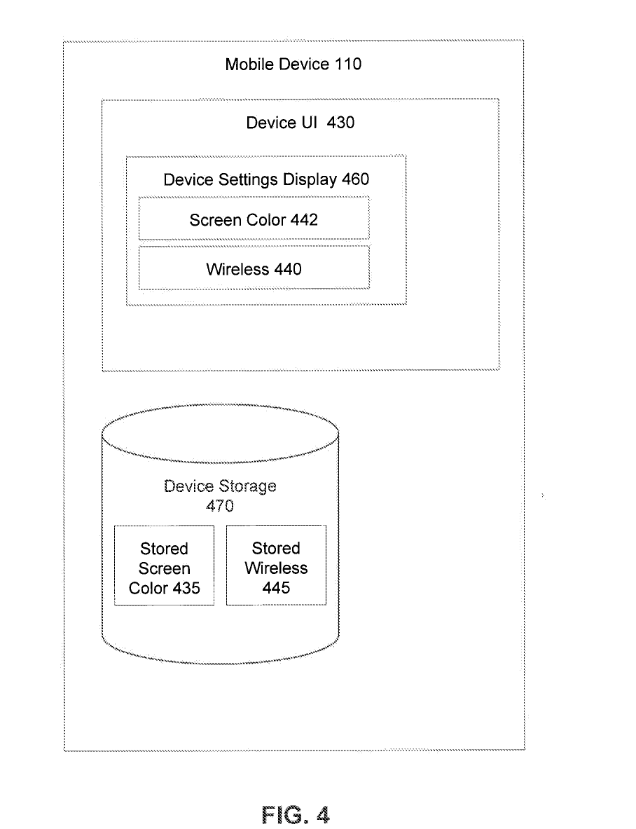

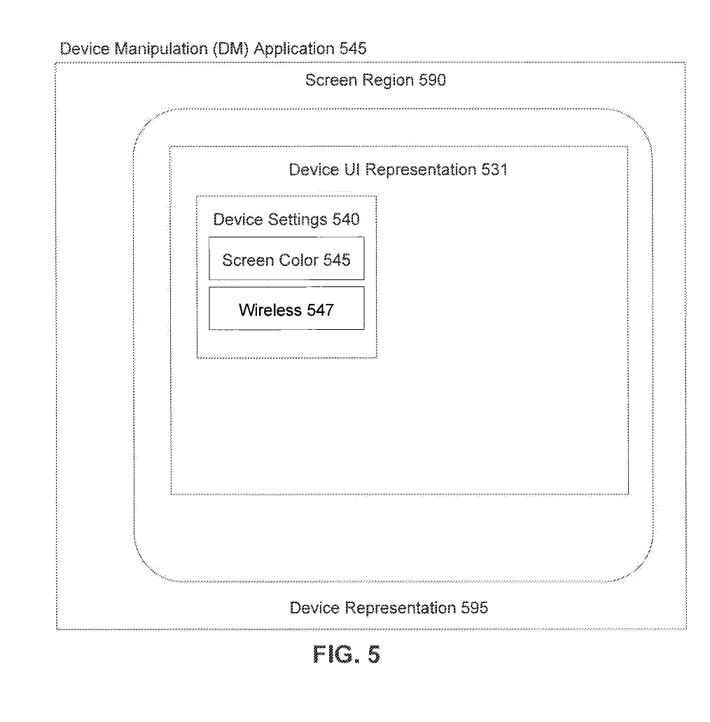

C2. Device Settings: Device settings are content items that store configuration information used by mobile device 110 to configure different aspects of the device. Further details regarding device settings as content items are provided with the description of FIGS. 4-5 below, according to an embodiment.

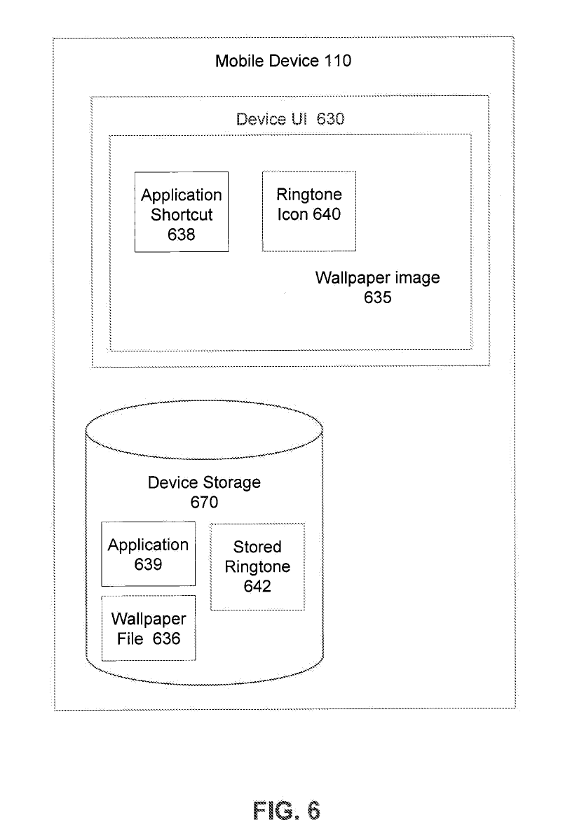

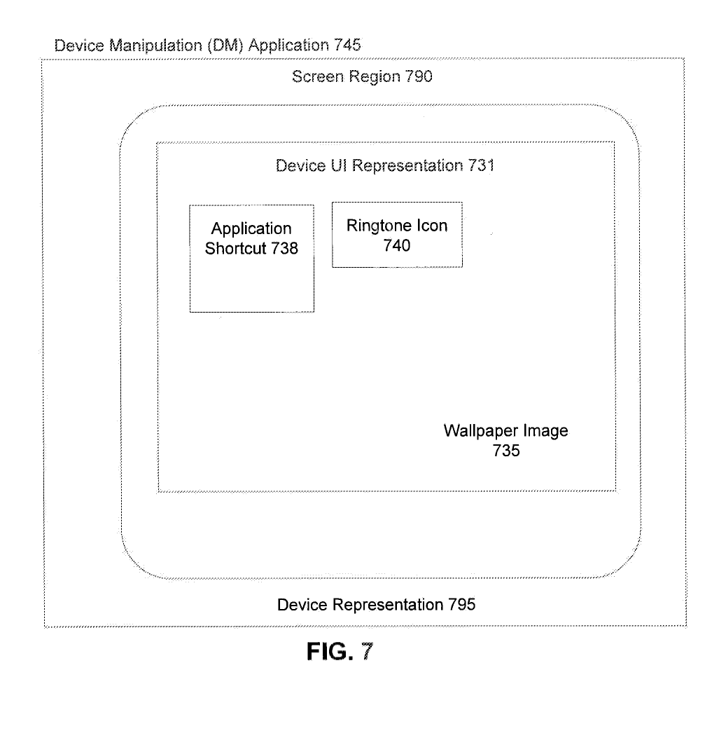

C3. Application Shortcuts: Application shortcuts are a content item that store a reference to an application installed on mobile device 110. Applications also can be content items that perform functions. Further details regarding application shortcuts as content items are provided with the description of FIGS. 6-7 below, according to an embodiment.

C4. Wallpaper: Wallpaper is a content item that is displayed as a background image on device UI 230 of mobile device 110. Further details regarding wallpaper as content items are provided with the description of FIGS. 6-7 below, according to an embodiment.

C5. Application Data: Application data content items are stored to provide data to different device applications: word processing files, spreadsheet files, audio files, video files and picture files.

C6. Folders: Example folder 237 stores and displays a list of file references 233A-B. Each file reference 233A-B refers respectively to corresponding files 273A-B stored in device storage 270. Similar to playlist 235 above, in an embodiment, folder 274 is a content item that contains one or more references to other content items, e.g., files 273A-B and application data examples described with item C5 above.

As would be appreciated by one having skill in the relevant art(s), given the description of content item examples C1-C6, other types of data stored on a managed device can be added, removed and modified using the approaches described herein.

In an embodiment, when using mobile device 110, user 105 interacts with mobile device 110 via device UI 230, such interaction potentially including the display of playlist 235, the visual and/or audio presentation of content items: playing videos, displaying pictures and playing audio content. Other interactions that can be enabled by device UI 230 include removing, copying and adding content items to mobile device 110. To support modification of a content item, information describing a content item can also be sent to a device using the network application.

As would be appreciated by one having skill in the relevant art(s), given the description herein, user 105 can have a familiarity with device UI 230 such that interacting with content items as illustrated above, can be accomplished faster than with using a user interface with which they are unfamiliar. An embodiment realizes an advantage in user experience by replicating, using a network-based application, the device UI of managed devices.

In an embodiment, to support DM application 145, content item sender 265 sends content items to server 120. In another embodiment, content item sender 265 sends an inventory of content items to server 120. From server 120, as described in further detail below, the content items and content item inventory are used in DM application 145.

In an embodiment, UI synchronizer 250 monitors device UI 230 and sends information that corresponds to the current state of device UI 230 to server 120. In a different embodiment, UI synchronizer 250 sends comprehensive user interface information to server 120, including different characteristics of the behavior of device UI 230. For example, UI synchronizer 250 can send sufficient information such that behavior of device UI 230 can be graphically replicated by server 120 and DM application 145 on the display screen of client computer 180. Further details regarding this replication behavior and the implementation of UI synchronizer 250 are provided with the description of 3, 5 and 7, below.

### Request to Modify a Content Item

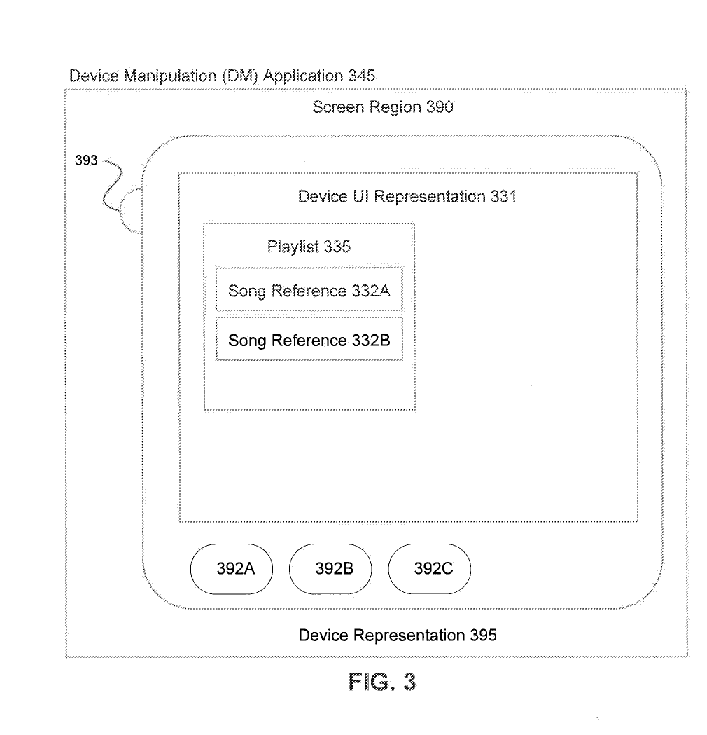

FIG. 3 depicts a more detailed view of DM application 145, referred to herein as DM application 345. DM application 345 includes screen region 390, screen region 390 having device representation 395. Device representation 395 is a graphical representation of mobile device 110, such representation, in an embodiment being a photorealistic image of mobile device 110. In another embodiment, device representation 395 is a line drawing of mobile device 110. Knob 393 and buttons 392A-C, for example, are examples of functional portions of device representation 395 that, in an embodiment, causes device representation to visually behave similar to mobile device 110.

In an example not intended to be limiting, mobile device 110 is a GOOGLE NEXUS ONE (™) phone offered by Google Inc., of Mountain View, Calif., and device representation 395 is an image or detailed line drawing of a GOOGLE NEXUS ONE phone.

In keeping with device representation 395 being a realistic depiction of mobile device 110, device UI representation 331 is a realistic representation of device UI 230 from FIG. 2. As noted above with the description of FIG. 2, an embodiment of UI synchronizer 250 on mobile device 110 is configured to send comprehensive information to server 120 including different characteristics of the behavior of device UI 230. DM application 345 receives this device UI 230 information from server 120 and replicates the behavior of device UI 230 in device UI representation 331.

As noted above with the description of FIG. 2, content item sender 265 sends content items and/or an inventory of content items to server 120. DM application 345 receives this device UI 230 information from server 120 and displays this information for manipulation.

It should be noted that, in different embodiments, it is not required that device UI representation 331 display exactly what currently appears on device UI 230, it is sufficient that the representation appear similar to a user. In other embodiments, device UI 230 and device UI representation 331 are synchronized by UI synchronizer 250 in real-time, substantially real-time or some other delay period. In another embodiment, device representation 395 is not used for manipulation of content items, the manipulation being performed by a classic menu-driven application approach.

Referring to aspects of FIGS. 1, 2 and 3, in a non-limiting example of the operation of DM manipulation application 145, the following steps S1-S6 are performed:

S1. Using web browser 140 operated on client computer 180, user 105 initiates a connection through network 101 to server 120.

S2. The connection established between client computer 180 and server 120 enables the initiation of a DM application 345. As noted above with respect to the description of FIG. 1, in an embodiment, server 120 performs the server-side functions of DM application 345.

S3. As noted above, DM application 345 displays device representation 395, such device representation 395 being a graphical representation of device UI 230. DM application. 345 displays device representation 395 as a manipulable user interface component. By manipulating device representation 395, user 105 can view, modify, add and delete content items are located on mobile device 110.

S4. Using device representation 395 in DM application 345, user 105 can delete, copy, move and otherwise manipulate content items stored on mobile device 110, in different embodiments, the manipulating of content items shown in device representation 395 can be performed using at least one of the steps of using a pointer to manipulate a graphical depiction of a physical control found on the device (e.g. knob 393), using a pointer to perform gestures on the physical depiction of the device user interface, using a pointer to manipulate the graphical depiction of the device in a simulated three dimensional display, using a pointer to cause the graphical depiction of the device to be graphically linked to a graphical depiction of a connector, cable or dock, using a pointer to manipulate a graphical depiction of a hinged portion of the device, using a pointer to manipulate a graphical depiction of a sliding portion of the device, and using a pointer to type on a graphical depiction of a keyboard found on the device.

S5. After the user manipulates content items represented on device representation 395, a request to modify the manipulated content items is generated by DM application 345. For example, if the user removes song reference 332B from playlist 335, a corresponding request for modification of mobile device 110 is created by DM application 345. As noted above, playlist 335 corresponds to playlist 235 on mobile device 110. Based on the manipulation of playlist 335 on device UI representation 331, a request to modify playlist 235 on mobile device 110 is generated.

S6. DM application 345 via client computer 180 and network 101, sends the generated request to modify playlist 235 to mobile device 110.

Steps S1-S6 above are intended to illustrate an example series of steps that can be performed with embodiments. As would be appreciated by one having skill in the relevant art(s), given the description herein, additional similar steps may be performed using embodiments, and/or not all of the above noted steps S1-S6 may be performed. In addition, steps S1-S6 may be performed in a different order by embodiments.

### Manipulating Content items

It should be appreciated that requests to modify content items can involve a broad variety of different actions. In an example not intended to be limiting, a request for modification can include one or more of the following instructions F1-F5 listed below:

F1. An instruction to remove a content item from device storage 270. For example a particular music file stored in device storage 270 can be deleted. In this case, the content item is the inventory of device storage 270.

F2. An instruction to rename a content item from device storage 270. For example a particular music file stored in device storage 270 can be renamed.

F3. An instruction to move or copy a content item from device storage 270. In this case, the content item is the inventory of device storage 270, and this inventory is modified to copy or move a file to another location. For example song 272B, stored in device storage 270 can be copied from one logical storage area (in device storage 270.

F4. Receive an instruction from server 120 to change setting of mobile device 110. For example, an instruction to the ringer volume of mobile device 110 can be received and implemented by device synchronizer 240.

F5. Receive an instruction from server 120 to receive a content item from server 120. For example, a music file can be received by mobile device 110 and stored in device storage 270.

As would be appreciated by one having skill in the relevant art(s), given the description herein, the instructions F1-F5 above illustrate the broad variety of instructions that can be directed to content items stored on a managed device.

Content item modifier 260 from FIG. 2, in an embodiment, enables the performance of the above-described request for modification generated by DM application 345.

### Device Settings

FIG. 4 depicts another detailed view of mobile device 110 according to an embodiment. Mobile device 110 includes device user interface (Device UI) 430 and device storage 470. Device UI 430 shows device settings display 460, screen color 442 setting; and wireless 440 setting. Each setting, screen color 442 and wireless 440 setting, refer respectively to corresponding stored settings, stored screen color 435 and wireless configuration 445.

As noted in item C2 with the description of FIG. 2 above, device settings are content items that store configuration information used by mobile device 110 to configure different aspects of the device. Screen color 442 for example, is a setting value for mobile device 110 screen color, as displayed on device UI 430. The corresponding value for screen color 442 is stored in device storage 270 as stored screen color 435. Similarly, stored wireless 445 setting is a setting value for wireless connections on mobile device 110, as displayed on device UI 430 as wireless 440 setting.

FIG. 5 depicts another detailed view of DM application 145, referred to herein as DM application 545. DM application 545 includes screen region 590, screen region 590 having device representation 595. Device representation 595 is a graphical representation of mobile device 110, such representation, in an embodiment being a photorealistic image of mobile device 110.

In keeping with device representation 595 being a realistic depiction of mobile device 110, device UI representation 531 is a realistic representation of device UI 430 from FIG. 4.

As described above with FIGS. 2-3, generally speaking, embodiments described herein allow a user to use a DM application 545 to manipulate settings of one or more mobile devices. For example, using DM application 745, stored screen color 435 can be modified by the manipulation of screen color 545 and stored wireless 445 setting can be modified by manipulating wireless 547.

### Application Shortcuts

FIG. 6 depicts another detailed view of mobile device 110 according to an embodiment. Mobile device 110 includes device user interface (device UI) 630 and device storage 670. Device UI 630 displays ringtone icon 640 and application shortcut 638, over wallpaper image 635. Application shortcut 638 refers to application 639 and ringtone icon 640 refers to stored ringtone 642, both stored in device storage 670.

As noted with item C3 in the description of FIG. 2 above, application shortcuts are content items that store a reference to an application installed on mobile device 110. On mobile device 110, application shortcut 638 can be used to trigger the execution of application 639. Application 639 is also a content item modifiable by an embodiment. Wallpaper image 635 is a visual representation of the background image displayed in device UI 630, such visual representation stored as stored wallpaper file 636 in device storage 670. Ringtone icon 640 is a symbolic depiction of stored ringtone 642 for use by a mobile device having a ringing function.

FIG. 7 depicts another detailed view of DM application 145, referred to herein as DM application 745. DM application 745 includes screen region 790, screen region 790 having device representation 795. Device representation 795 is a graphical representation of mobile device 110, such representation in an embodiment, being a photorealistic image of mobile device 110. Device UI representation 731 displays ringtone icon 740 and application shortcut 738, over wallpaper image 735.

In keeping with device representation 795 being a realistic depiction of mobile device 110, device UI representation 731 is a realistic representation of device UI 630 from FIG. 6.

As described above with FIGS. 2-5, generally speaking, embodiments described herein allow a user to use a DM application 745 to manipulate content items on mobile device 110. For example, using DM application 745, stored ringtone 642 can be modified by the manipulation of ringtone icon 740, a new application 639 can be installed in device storage 670 and wallpaper image 735 can be changed.

### Network-Based Application Server

FIG. 8 depicts an example network application architecture 800 in which embodiments of the present invention, or portions thereof, may be implemented. Network application architecture 800 includes the following components: network 101, server 120 and server storage 170. Server 120 includes content item processor 820, user-interface replicator (UI replicator) 830 and content verifier 840. Server 120 is coupled to both network 101 and server storage 170.

As discussed in the embodiment of FIG. 2, UI synchronizer 250 on mobile device 110 sends comprehensive user interface information to server 120, including different characteristics of the behavior of device UI 230. UI synchronizer 250 can send sufficient information such that behavior of device UI 230 can be graphically replicated on browser screen 145.

In an embodiment, UI replicator 830 receives the UI information from UI synchronizer 250 and sends UI display information to DM application 145. On DM application 145, device representation 115 can be created for user 105 based on the information sent by UI replicator 830. The information gathered and sent by UI synchronizer 250 enables a display in DM application 145 of the content item as it would appear on a display of the mobile device both before and after a requested modification to the content item is performed.

As also described above with the description of FIG. 2, in an embodiment, to support DM application 145, content item sender 265 sends content items to server 120. In another embodiment, content item sender 265 sends an inventory of content items to server 120. From server 120, as described in further detail below, the content items and content item inventory are used in DM application 145. In an embodiment, content item processor 820 receives the content items and content item inventories sent by content item sender 265 and supports the execution of DM application 145. Because server 120 can be located in a centralized position vis a vis one or more content item devices and a user, in an embodiment, content verifier 840 can verify different characteristics of different content items.

The following list L1-L4 is intended to be an illustrative, non-limiting list of different characteristics of content items that can be verified. In different embodiments, characteristics can be pre-determined or configured by a user. Items L1-L4 are as follows:

L1. Whether the content item has a valid license under a digital rights management (DRM) structure. For example, a song uploaded by a user may not have a current license. Content verifier 840, in this example, can prevent the song from being distributed to managed devices. In another embodiment, content verifier 840 can provide notification to the user about different determined content item characteristics. For example, in the missing license example above, the user can be notified about the lack of current license.

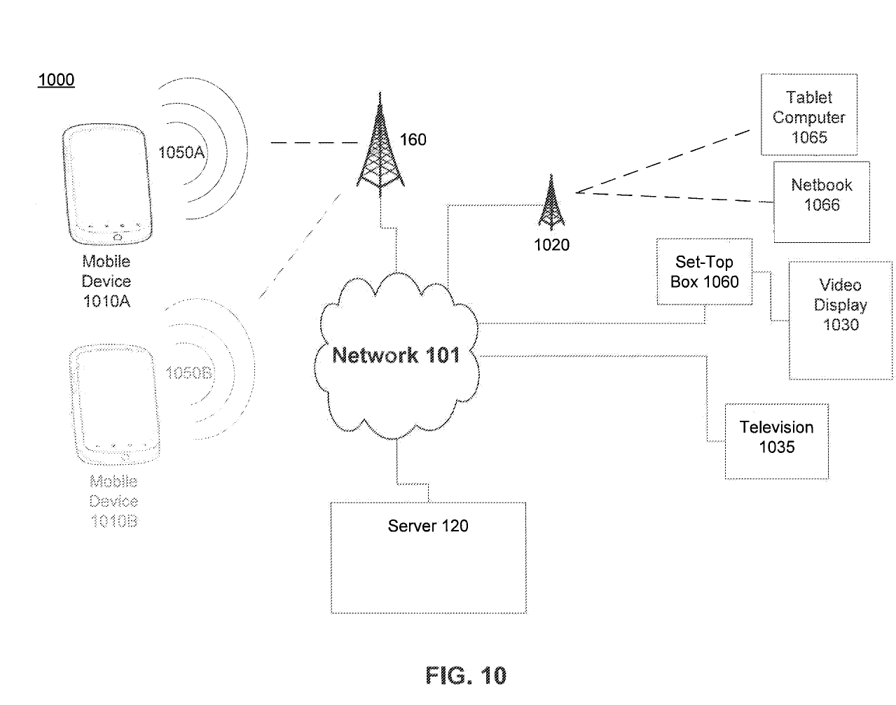

L2. Whether a content item is compatible with a managed device. As described further below with the description of FIG. 10, content item modifications, additions and deletions can be distributed to multiple types of devices. A wireless setting, for example, changed on a wireless device can be blocked by content verifier 840 from being distributed to a set-top box. Another example of this includes the verification that a target device has the required video and audio decoders to process compressed video and audio files.

L3. Whether a compressed media content item has a sufficient bit rate to maintain a playback quality level. This is an example of a potentially user-defined verification characteristic. Because of audio quality requirements, for example, a user can specify that all audio files on managed devices have at least a 128 kbps bit rate.

L4. Different devices can have different specialized capabilities, for example a telephonic device can have capabilities with respect to playing polyphonic ring tones, while a laptop computer using a telephonic application may not have the capability. Content verifier 840 can be configured to determine whether a device can use a content item before the content item is sent to the device.

As would be appreciated by one having skill in the relevant art(s), given the description herein, items L1-L4 above illustrate that a variety of different verification characteristics can be used by content verifier 840, according to embodiments.

### Adding Content Items

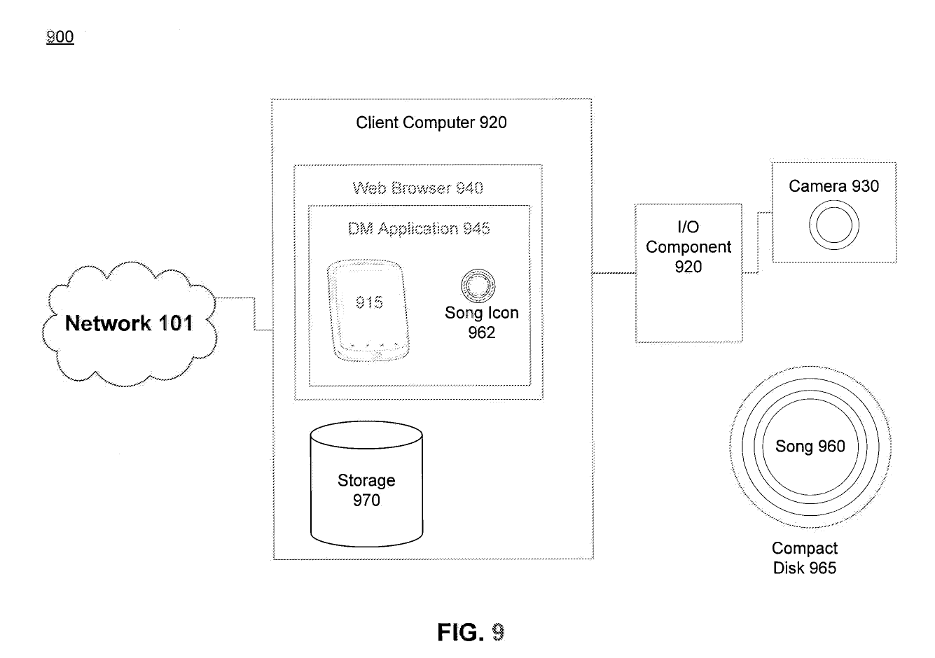

FIG. 9 depicts an example network application architecture 900 in which embodiments of the present invention, or portions thereof, may be implemented. Network application architecture 900 includes the following components: network 101, client computer 920, input/output component (I/O component) 920, camera 930 and compact disk 965. Client computer 920 includes web browser 940 and storage 970. Web browser 940 includes DM application 945, such DM application 945 having a user interface that depicts device representation 915 and song icon 962. Song icon 962 refers to song 960 stored on compact disk 965.

As discussed above with FIGS. 1-8, according to an embodiment, DM application 945 provides a graphical depiction 915 the mobile device 110 to the user, and manipulation of this device representation 915 can result in a request to modify a corresponding content item on mobile device 110.

According to an embodiment, DM application is also configured to receive content items and transfer these to mobile device 110. For example, compact disk 965 has one or more songs (content items), and I/O component 920 can manage the retrieval and conversion of these songs into an electronic format usable by mobile device 110. A user working with DM application 945 sees file source 942 and manipulates it as a graphical representation of compact disk 965. The content item manipulation functions described above are described with FIG. 2-9

In an embodiment, to enable the addition of song 960 to mobile device 110, server 120 receives a content inventory from mobile device 110 and uses this information to generate device representation 915 in DM application 945. User 105 can use the graphical manipulation approaches described with FIG. 3 above to request the addition of song 960 (via song icon 962) to mobile device 110 (via device representation 915). As would be appreciated by one having skill in the relevant art(s), given the description herein, a variety of different content items, content item sources may be used by different embodiments to select content items for addition.

Once content item song 960 has been requested for addition, song 960 can be uploaded from client computer to server 120 and transferred to mobile device 110. As would be appreciated by one having skill in the relevant art(s), given the description herein, content items can come from a variety of sources, for example, server 120, a connected server configured to store content items (content server 130), client computer 920, a device connected to client computer 920 (camera 930) and from another device managed by embodiments (as discussed with the description of FIG. 10 below).

### Multiple Device Management

FIG. 10 depicts an example network application architecture 1000 in which embodiments of the present invention, or portions thereof, may be implemented. Network application architecture 1000 includes network 101, server 120, and wireless transceiver 160. Mobile devices 1010A-B are depicted linked by respective wireless signals 1050A-B to wireless transceiver 160, server 120 has server storage 170.

FIG. 10 depicts a variety of devices with the capacity to store and display content items, both mobile (mobile devices 1010A-B, tablet computer 1065 and netbook 1066) and non-mobile (set-top box 1060 and television 1035). Tablet computer 1065 and netbook 1066 is wirelessly coupled to network 101 via short-range wireless network receiver 1020.

As used herein, set-top box (STB) 1060, also known as a set-top unit (STU), typically refers to a device that connects to a television/video display and an external source of signal, turning the signal into content which can then be stores and displayed, for example set-top box 1060 receiving a signal from network 101 and displaying content on video display 1030. An example embodiment of set-top box 1060 is the GOOGLE TV component offered by Google Inc., of Mountain View, Calif.

In different embodiments, the approaches to modifying, adding and removing content items on devices can be used to manage content items across multiple devices in an integrated fashion. In an example, user 105 desires to modify a content item on multiple mobile devices and non-mobile devices using a single integrated approach. Using the approach described with the description of FIGS. 2-3, DM application 145, user 105 can modify playlist 235 on mobile device 1010A, then have this request for modification propagated to tablet computer 1065, netbook 1066, STB 1060, television 1035 and other similar content item devices.

It should be appreciated that different embodiments can add and remove content items from associated devices using a variety of different approaches. Approaches used by embodiments include a content item synchronization approach, where adding, modifying or removing content items on one device automatically leads to the same result on a related device. For example, adding a content item to netbook 1066 can be synchronized with mobile device 1010A via server 120 and approaches described herein. Device settings, as discussed with the description of FIG. 4, can also by synchronized across coupled devices in this way.

As would be appreciated by one having skill in the relevant art(s), given the description herein, different content items can have different configurations based on the type of content device upon which they are used. For example, an encoded music file (e.g., MP3 encoded audio) can have different bit rate configurations based on the amount of storage available on a device.

In an example, using processes described FIG. 9 above, a user adds a song to both mobile device 1010A and tablet computer 1065. In an embodiment, DM application 145 can be configured to send a different version of the added song to mobile device 1010A and tablet computer 1065 based on the characteristics of the devices. In this example, because of the smaller amount of storage available on mobile device 1010A as compared to tablet computer 1065, a lower bit rate version of the song is sent to the former. In another embodiment, DM application 145 automatically modifies added content items based on different characteristics of receiving devices. One having skill in the relevant art(s), given the description herein, would appreciate a variety of different changes that can be made to requests for modification and to content items based on the type and characteristics of different receiving devices.

As noted above, configuration settings can also be applied to coupled devices using an embodiment. As with the different versions of content items sent to different types of devices described above, configuration settings can also be modified before being sent out to different types of devices. For example, an embodiment can be configured such that configuration changes to tablet computer 1065 are sent and implemented at mobile device 1010A. If, for example, a user selects a background color on tablet computer 1065 that does not exist on mobile device 1010A, a similar background color can be selected and sent to mobile device 1010A.

In an example that combines both configuration synchronization and content item synchronization across multiple devices, a user may be attending a concert by a particular band and Multiple types of related content items can be sent to connected devices. Using an embodiment, music from the band (encoded with appropriate bit-rates) can be added to multiple connected devices, e.g., mobile devices 1010A-B, set-top box 1060 and netbook 1066. In addition, the wallpaper configuration of these devices can also be changed to present graphics related to the band. On selected devices, e.g., telephonic devices 1010A-B, a ringtone configuration can also be changed.

### Method 1100

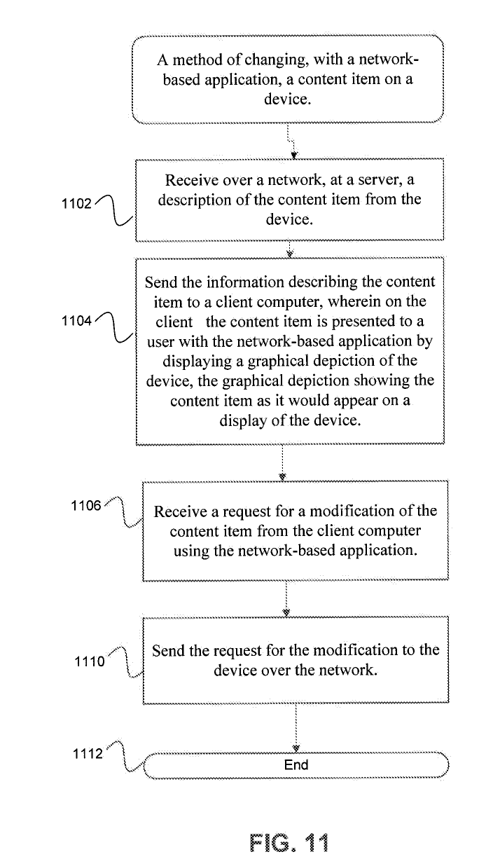

FIG. 11 illustrates a more detailed view of how embodiments described herein may interact with other aspects. In this example, a method of changing, with a network-based application, a content item on a device is shown. Initially, as shown in stage 1102 in FIG. 11, over a network, a content item is received at a server from the device. For example, in an embodiment, a content item, for example playlist 235 from FIG. 2, is received from a device, for example mobile device 110 from FIG. 1, at a server, for example server 120 from FIG. 1, over a network, for example, network 101 from FIG. 1.

At stage 1104, the content item is sent to a client computer, and on the client computer the content item is presented to a user with the network-based application by displaying a graphical depiction of the device, the graphical depiction showing the content item as it would appear on a display of the device. For example, in an embodiment, the content item, for example playlist 235, is sent to a client computer, for example client computer 180 from FIG. 1, and the content item is presented to a user, for example user 105, using a network-based application, for example DM application 345 by displaying a graphical depiction of the device, for example the device representation 395, the graphical depiction showing the content item as it would appear on a display of the device, for example song reference 332A in device UI representation 331. As a further example, playlist 235 can be displayed in way similar to its presentation on mobile device 110, using a graphical representation, for example device representation 115 from FIG. 1.

At stage 1106, a request for a modification of the content item is received from the client computer using the network-based application. For example, in an embodiment, a request to modify a content item, for example a request to remove a song 332A from playlist 335, is received from the client computer using the network-based application, for example client computer 180 using DM application 145.

At stage 1110, the request for the modification is sent to the mobile device over the network. For example, in an embodiment, the above-noted request for modification, the request to remove a song 332A from playlist 335, is sent to the device, for example mobile device 110. At mobile device 110, the request for modification is received by content item modifier 260, and the corresponding, stored playlist 271, has corresponding song 272A removed. After stage 1110, method 1100 ends at 1112.

### Example Computer System Implementation

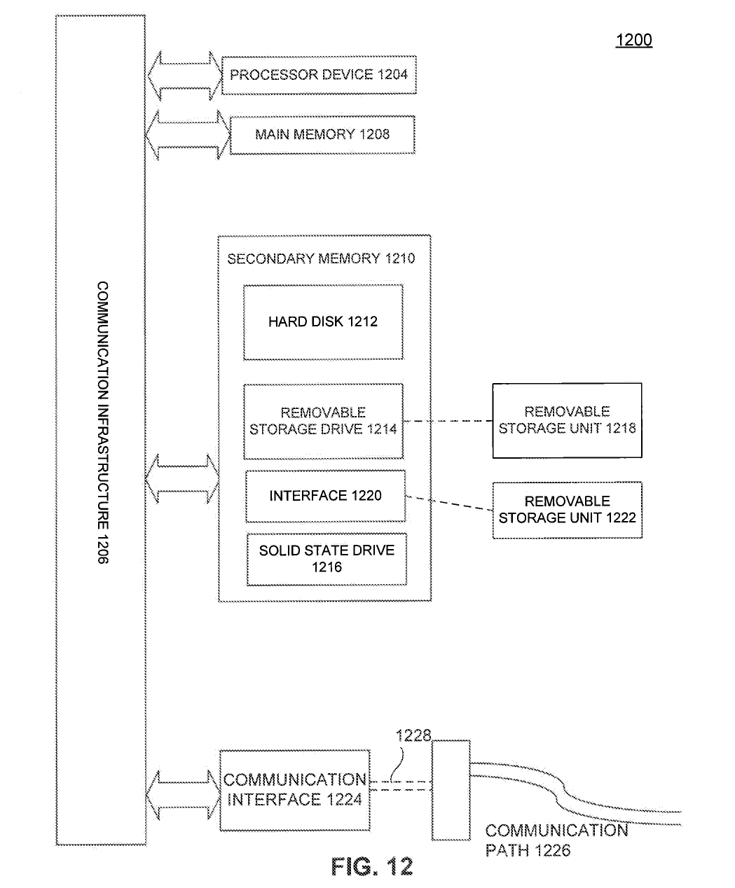

FIG. 12 illustrates an example computer system 1200 in which embodiments of the present invention, or portions thereof, may be implemented. For example, portions of systems or methods illustrated in FIGS. 1-11 may be implemented in computer system 1200 using hardware, software, firmware, tangible computer readable media having instructions stored thereon, or a combination thereof and may be implemented in one or more computer systems or other processing systems. Hardware, software or any combination of such may embody any of the modules/components in FIGS. 1-10 and any stage in FIG. 11. Mobile device 110, server 120, content server 130, client computer 180, tablet computer 1065, netbook 1066 can also be implemented having components of computer system 1200.

If programmable logic is used, such logic may execute on a commercially available processing platform or a special purpose device. One of ordinary skill in the art may appreciate that embodiments of the disclosed subject matter can be practiced with various computer system and computer-implemented device configurations, including smartphones, cell phones, mobile phones, tablet PCs, multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 1200. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1204 may be a special purpose or a general purpose processor device. As will be appreciated by persons skilled in the relevant art, processor device 1204 may also be a single processor in a multi-core/multiprocessor system, such system operating alone, or in a cluster of computing devices operating in a cluster or server farm. Processor device 1204 is connected to a communication infrastructure 1206, for example, a bus, message queue, network or multi-core message-passing scheme.

Computer system 1200 also includes a main memory 1208, for example, random access memory (RAM), and may also include a secondary memory 1210. Secondary memory 1210 may include, for example, a hard disk drive 1212, removable storage drive 1214 and solid state drive 1216. Removable storage drive 1214 may include a floppy disk drive, a magnetic tape drive, an optical disk drive, a flash memory, or the like. The removable storage drive 1214 reads from and/or writes to a removable storage unit 1218 in a well known manner. Removable storage unit 1218 may include a floppy disk, magnetic tape, optical disk, etc. which is read by and written to by removable storage drive 1214. As will be appreciated by persons skilled in the relevant art, removable storage unit 1218 includes a computer usable storage medium having stored therein computer software and/or data.

In alternative implementations, secondary memory 1210 may include other similar means for allowing computer programs or other instructions to be loaded into computer system 1200. Such means may include, for example, a removable storage unit 1222 and an interface 1220. Examples of such means may include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to computer system 1200.

Computer system 1200 may also include a communications interface 1224. Communications interface 1224 allows software and data to be transferred between computer system 1200 and external devices. Communications interface 1224 may include a modem, a network interface (such as an Ethernet card), a communications port, a PCMCIA slot and card, or the like. Software and data transferred via communications interface 1224 may be in electronic, electromagnetic, optical, or other forms capable of being received by communications interface 1224. This data may be provided to communications interface 1224 via a communications path 1226. Communications path 1226 carries the data and may be implemented using wire or cable, fiber optics, a phone line, a cellular phone link, an RF link or other communications channels.

In this document, the terms “computer program medium” and “computer usable medium” are used to generally refer to media such as removable storage unit 1218, removable storage unit 1222, and a hard disk installed in hard disk drive 1212. Computer program medium and computer usable medium may also refer to memories, such as main memory 1208 and secondary memory 1210, which may be memory semiconductors (e.g., DRAMs, etc.).

Computer programs (also called computer control logic) may be stored in main memory 1208 and/or secondary memory 1210. Computer programs may also be received via communications interface 1224. Such computer programs, when executed, enable computer system 1200 to implement the present invention as discussed herein. In particular, the computer programs, when executed, enable processor device 1204 to implement the processes of the present invention, such as the stages in the method illustrated by flowchart 1100 of FIG. 11 discussed above. Accordingly, such computer programs represent controllers of the computer system 1200. Where the invention is implemented using software, the software may be stored in a computer program product and loaded into computer system 1200 using removable storage drive 1214, interface 1220, hard disk drive 1212 or communications interface 1224.

Embodiments of the invention also may be directed to computer program products comprising software stored on any computer useable medium. Such software, when executed in one or more data processing devices, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### Conclusion

Embodiments described herein relate to the manipulation of device content using a network based application. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A method of modifying, with a network-based application, an inventory of one or more content items on a mobile device, comprising:
receiving, over a network at a client computer from a server, the inventory on the mobile device;
presenting, on the client computer, a graphical depiction of the mobile device, the graphical depiction showing the inventory as the inventory would appear on a display of the mobile device;
receiving, by the client computer, a request for a modification of the inventory; and
sending, to the mobile device over the network via the server, the request for the modification to the mobile device.

2. The method of claim 1, wherein presenting a graphical depiction of the mobile device comprises presenting a graphical depiction of the mobile device showing the inventory as the inventory would appear on a display of the mobile device before the requested modification is performed.

3. The method of claim 1, farther comprising presenting a graphical depiction of the mobile device showing the inventory as the inventory would appear on a display of the mobile device after the requested modification is performed.

4. The method of claim 3, wherein the request for a modification comprises manipulating the inventory shown on the graphical depiction of the mobile device in the networked application.

5. The method of claim 4, wherein the request for the modification comprises at least one of:
a manipulation of a graphical depiction of a physical control found on the mobile device,
a manipulation of a graphical depiction of the mobile device user interface,
a manipulation of a graphical depiction of the mobile device in a simulated three dimensional display,
a manipulation of a graphical depiction of the mobile device and a graphical depiction of a connector, cable or dock,
a manipulation of a graphical depiction of a hinged portion of the mobile device,
a manipulation of a graphical depiction of a sliding portion of the mobile device, and
a manipulation of a graphical depiction of a keyboard found on the mobile device.

6. The method of claim 1, wherein receiving the inventory comprises receiving the inventory from a mobile phone, a tablet computer, or a netbook computer.

7. The method of claim 1, wherein the receiving the inventory comprises receiving one or more of:
a playlist of audio files,
an inventory of a folder,
an inventory of text files,
an inventory of applications,
an inventory of wallpaper files, and
an inventory of video files playlist of video files.

8. The method of claim 1, wherein presenting on the client computer a graphical depiction showing the inventory comprises presenting the graphical depiction in a web browser operating on the client computer.

9. A network-based application, comprising:
a content item processor configured to receive information describing an inventory of one or more content items from a device; and
a user interface (UI) replicator configured to:
receive a UI signal from the device, wherein the UI signal corresponds to a state of a UI on the device, and
generate, at a client computer, a graphical depiction of the state of the UI on the device, the graphical depiction showing the inventory as it would appear on the UI of the device,
wherein the content item processor is further configured to:
receive a request to modify the inventory from the client computer,
generate a modification signal to send to the device based on the request, and
send the modification signal to the device.

10. The network-based application of claim 9, wherein the graphical depiction shows the inventory as it would appear on a display of the device before the requested modification is performed.

11. The network-based application of claim 9, wherein the graphical depiction shows the inventory as it would appear on a display of the device after the requested modification is performed.

12. The network-based application of claim 9, wherein the request for a modification is generated by manipulating the inventory shown on the graphical depiction of the device in the network-based application.

13. The network-based application of claim 9, wherein the request to modify the inventory is generated using at least one of:
using a pointer to manipulate a graphical depiction of a physical control found on the device,
using a pointer to manipulate the physical depiction of the device user interface,
using a pointer to manipulate the graphical depiction of the device in a simulated three dimensional display,
using a pointer to cause the graphical depiction of the device to be graphically linked to a graphical depiction of a connector, cable or dock,
using a pointer to manipulate a graphical depiction of a hinged portion of the device,
using a pointer to manipulate a graphical depiction of a sliding portion of the device, and
using a pointer to type on a graphical depiction of a keyboard found on the device.

14. The network-based application of claim 9, wherein the content item processor is configured to receive the inventory from a mobile phone, a tablet computer or a netbook computer.

15. The network-based application of claim 9, wherein the content item processor is configured to receive:
a playlist of audio files,
an inventory of a folder,
an inventory of text files,
an inventory of applications,
an inventory of wallpaper files, and
an inventory of video files.

16. The network-based application of claim 9, wherein the UI replicator is configured to generate the graphical depiction of the state of the UI at the client computer in a web browser operating on the client computer.

17. A computer-readable storage medium having computer-executable instructions stored thereon that, when executed by a computing device, cause the computing device to perform operations for modifying, with a network-based application, an inventory of one or more content items on a mobile device, the operations comprising:
receiving, over a network at a client computer from a server, the inventory on the mobile device;
presenting, on the client computer, a graphical depiction of the mobile device, the graphical depiction showing the inventory as the inventory would appear on a display of the mobile device;
receiving, by the client computer, a request for a modification of the inventory; and
sending, to the mobile device over the network via the server, the request for the modification to the mobile device.
